(19) United States
(12) Patent Application Publication
(10) Pub. No.: US 2025/0043901 A1
(43) Pub. Date: Feb. 6, 2025

(54) FLUID TRANSPORT PIPE HAVING A STEEL TUBE WITH A PROTECTIVE LINING PROVIDED WITH SLOTS FOR DISCHARGING GAS BUILT UP UNDER THE LINING

(71) Applicant: SAIPEM S.A., Montigny le Bretonneux (FR)

(72) Inventors: Thomas DELAPLACE, Clichy (FR); Raymond HALLOT, Voisins le Bretonneux (FR); Olivier LE GUENNEC, Auffargis (FR); Nicolas SINGLING, Vincennes (FR)

(21) Appl. No.: 18/716,215

(22) PCT Filed: Dec. 12, 2022
(86) PCT No.: PCT/FR2022/052317

§ 371 Date: Jun. 4, 2024

(30) Foreign Application Priority Data
Dec. 17, 2021 (FR) 21 13893

(51) Int. Cl. F16L 58/10

(52) U.S. Cl. CPC F16L 58/1036

(57) ABSTRACT

A pipeline for the transport of fluids includes a steel tube intended to receive a flow of fluids to be transported, and an annular lining for protection against corrosion and/or abrasion made of polymer material, and inserted inside the tube. The lining includes a plurality of slots which extend in the direction of their length parallel to a longitudinal axis of the tube and which pass all the way from an inner face to an outer face of the lining, each slot being open on the side of the inner face of the lining prior to the insertion of the lining into the tube, and at least partially closed between the inner face and the outer face of the lining along of its depth once the lining is inserted into the tube.

### TECHNICAL FIELD

The present invention relates to the general field of subsea or onshore steel and coated pipelines which are used for the transport of fluids such as hydrocarbons, in particular oil and gas, or hydrogen or CO₂.

It more specifically concerns a solution to avoid buckling of the inner lining of such pipelines under the coating during sudden depressurization of the line due to permeation and accumulation of gas.

### PRIOR ART

Subsea pipelines used for the transport of hydrocarbons, in particular oil and gas, derived from subsea production wells are generally made of a tube made of steel.

The fluids transported are sometimes corrosive to the steel that makes up the tubes due to one or more constituents such as carbon dioxide or hydrogen sulphide. Also, to protect them against corrosion, it is known to insert or apply inside the steel pipeline a layer of corrosion-resistant nickel-based alloy steel—typically having a thickness of the order of 3 mm or more. The corrosion-resistant alloy steel layer will protect the mechanical integrity of the steel pipeline by isolating it from the transported fluid and preserving it from induced corrosion. This layer of alloy steel can be inserted in the form of a liner or applied by deposition of material on the inner surface of the steel pipeline—(this technique is called “CRA lining” for “Corrosion Resistance Alloy lining” in the industry). This effective solution is however very expensive.

A first alternative to the alloy steel lining is the application of an anti-corrosion protective layer in the form of a thin coating, made for example with the application of epoxy polymer resin, more commonly called “epoxies”, typically having a thickness of the order of a few hundred micrometers. Although more economical to purchase and manufacture than using an alloy steel lining, these thin coatings have the disadvantage of being sensitive to scratches and abrasion, which can result in exposing some parts of the steel pipeline, thus exposing it to the risk of corrosion. Anti-corrosion chemicals are usually injected preventively into the transported fluid to reduce the risk of corrosion in the potentially exposed areas of the steel pipeline, thereby increasing the operational costs of using the pipeline.

As another alternative, this solution can be replaced by the insertion of an annular protective lining—typically having a thickness of the order of 10 mm—made of polymer material, for example thermoplastic material. The protective lining is typically inserted by pulling through a diameter reduction system and then inside the steel tube to press against the inner surface of the tube once the pulling force is released to obtain a tight fit. The protective lining then isolates the steel pipeline from the transported fluid and protects it from the risk of induced corrosion. The thickness of the polymer liner protects it from the risk of scratches and abrasion during the life of the pipeline. This technique is quite commonly used for liquid transport pipelines such as injection water for example, but less widespread for multi-phase production fluid transport lines.

Although more economical than the usual technique known as “CRA lining” technique, the polymer material lining has the disadvantage of being permeable to gases and vapors coming from the transported fluids. Also, in practice, gas tends to penetrate the polymer material and to pass through the protective lining in order to lodge in the interstitial space between the lining and the inner wall of the steel tube.

Over time, gases and vapors will accumulate in the interstitial space, the permeation phenomenon being controlled by the operating pressure of the transported fluid, and thus create over time, with the permeation phenomena not being usually immediate, an accumulation of pressurized gas under the lining, more or less uniformly distributed over the length of the pipeline. However, when the pipeline will be depressurized, the permeation rate of the protective lining is not high enough to allow reducing the pressure inside the interstitial space at the same speed as the pressure drop inside the pipeline. A pressure differential is then created with an over-pressurization on the side of the interstitial space, with a risk of occurrence of local buckling or collapse of the protective lining.

The local and uncontrolled collapse of the protective lining during depressurization of the pipeline may have the consequence of compromising the integrity of the protective lining and therefore its effectiveness as a protection against corrosion of the steel constituting the tube. In addition, when the pipeline is re-pressurized, there is a risk that the part of the protective lining which has collapsed will not be able to return to its initial shape against the inner wall of the tube, thus being able to locally modify the passage section for the transported fluid which can lead to increases in head losses for example or to a modification in the resilience over time of the polymer lining.

Several solutions have been envisaged to resolve this problem of uncontrolled collapse of the protective lining during the pipeline depressurization. Some involve applying an adhesive coating on the inner surface of the steel tube to increase the adhesion between the thermoplastic lining and the steel pipeline, thereby increasing the collapse resistance of said lining while limiting the volume of the interstitial space under the liner and therefore the amount of gas that could possibly accumulate there. Other known solutions consist in forming grooves on the outer face of the lining so as to collect the gases that have passed through the lining and discharge them to the outside of the pipeline via outer ports made in the tube. This degassing operation can be carried out continuously or at regular intervals.

Yet another solution consists in making cylindrical perforations in the protective lining so as to put the interstitial space in contact with the inside of the lining. In the event of depressurization of the pipeline, the gases having passed through the lining will follow these perforations to be discharged from the inside of the lining so as to keep the pressure differential below the collapse pressure of the lining.

All the solutions of the prior art presented above have drawbacks. Particularly, the use of an adhesive coating on the inner surface of the steel tube has the disadvantage of a significant complexity of the implementation process which requires several phases of application of different layers followed by baking phases to create the adhesion. Furthermore, the use of outer gas discharge ports requires drilling the steel tube, which weakens the mechanical integrity of the tube, and providing a gas discharge line into the subsea environment, which increases the complexity of the system, the installation procedures and the risk of leaks. In addition, this solution requires maintenance operations to activate the degassing operation. The grooves made on the outer surface of the liner are also subject to plugging and accumulation of liquid which can reduce the effectiveness of the ventilation.

The solution consisting in making cylindrical perforations in the protective lining has the disadvantage of continually putting the transported fluids in contact with the steel tube, with the risk of locally generating corrosion. In addition, during their lifetime, these cylindrical perforations are subject to clogging, because they can be easily filled with sand, hydrocarbon wax, or be the site of bacteria proliferation.

### DISCLOSURE OF THE INVENTION

The present invention aims to propose a pipeline for the transport of fluids making it possible to limit or avoid the collapse of a protective lining during depressurization of the pipeline which does not present the disadvantages aforementioned.

This aim is achieved thanks to a pipeline for the transport of fluids comprising a steel tube intended to receive a flow of fluids to be transported, and an annular lining for protection against corrosion and/or abrasion made of polymer material, preferably a thermoplastic material, and inserted inside the tube, and in which, in accordance with the invention, the lining comprises a plurality of slots which extend in the direction of their length parallel to a longitudinal axis of the tube and which pass all the way from an inner face to an outer face of the lining, each slot being open on the side of the inner face of the lining prior to the insertion of the lining into the tube, and at least partially closed between the inner face and the outer face of the lining along its depth once the lining is inserted into the tube.

The invention is based on the concept of slots which allow the gas that has infiltrated into the annular space between the tube and the lining to be discharged into the tube when a depressurization of the line occurs. Particularly, the specific shape of the slots and their arrangement parallel to the longitudinal axis of the tube make it possible to minimize the risk of penetration of dirt/solids into the slots, while allowing their rapid and efficient opening to discharge the gas accumulated in the annular space when a depressurization occurs.

Indeed, thanks to this design, the opening on the side of the inner face of the lining is reduced to a minimum, which makes it possible to avoid the penetration of dirt, waxes or other potential plugging materials. In addition, in the event of depressurization of the pipeline, the shape of the slots promotes the opening on the side of the interior of the tube because the gas that has accumulated in the annular space will apply, when it will follow the slots, a pressure on the side edges thereof. The higher the pressure difference between the annular space and the interior of the tube, the greater the widening of the slots on the side of the interior of the tube. Thus, the gas will be easily discharged towards the interior of the tube during the depressurization of the pipeline. As the discharge of the gas accumulated under the liner towards the pipeline will lower the pressure differential between the interstitial space and the pipeline, the slots will close as soon as the pressure difference becomes sufficiently low again. These slots thus operate like check valves for the discharge towards the pipeline of the gas accumulated under the lining.

Furthermore, the design of the slots according to the invention makes it possible to treat the potential depositions of solids at the level of the slots on the inner side. Indeed, the greater the pressure difference between the annular space and the interior of the tube, the greater the opening of the slots due to the additional pressure of the gas accumulated in the annular space. If there is a layer of solid material deposition on a slot on the inner side, it will locally temporarily block or reduce the discharge of the permeation gas towards the interior of the tube, which will further increase the pressure differential. The opening on the side of the inner face of the lining will then increase, thus cracking the deposition layer and allowing the gas to be discharged. The discharge of the gas will cause the deposition together with the gas, thus cleaning the inner surface of the lining in the area of the slot.

In the unlikely event of additional local blockage of a slot, the behavior of the lining itself, combined with the design of the slot, will unblock the situation. Indeed, even if the gas will not be able to locally escape from the annular space and it is not able to reach other slots, the lining will begin to deform locally and the change in the shape of the lining will quickly promote the opening of the slots and the cracking of the surface of the deposition, ultimately allowing the permeation gas to escape.

Moreover, the slots are oriented in the same direction as the tube, and therefore as the polymer material lining. This allows minimizing the impact on the mechanical strength of the lining during the process of its insertion into the tube and during the operations of installation and lifetime of the pipeline.

In addition, the variation in the state of stress in the lining due to swelling by absorption of part of the transported fluid, at the pressure or at the compression or axial tension related to the thermal variations or to the geometry in-situ of the pipeline does not harm the effectiveness of the slots according to the invention.

Preferably, each slot has, in cross section and prior to the insertion of the lining into the tube, an outer opening at the level of the outer face of the lining which communicates via a groove with an inner opening at the level of the inner face of the lining.

In a first embodiment, each slot has, in cross section and prior to the insertion of the lining into the tube, a rectangle shape with an outer opening having the same width as the inner opening.

In a second embodiment, each slot has, in cross section and prior to the insertion of the lining into the tube, a trapezoid shape with an outer opening of greater width than the inner opening.

In a third embodiment, each slot has, in cross section and prior to the insertion of the lining into the tube, an outer opening and an inner opening of rectangular shape with the outer opening of greater width than the inner opening, and a groove having the shape of an isosceles trapezoid.

In this third embodiment, the outer and inner openings of each slot can be aligned along the perpendicular bisector of the groove, the two non-parallel sides of the groove forming, in cross section, an angle comprised between 20° and 45° with the perpendicular bisector.

Likewise, prior to the insertion of the lining into the tube, the outer opening of each slot can measure between 1 and 10 mm and the inner opening of each slot can measure between 0.2 and 4 mm.

In a fourth embodiment, each slot has, in cross section and prior to the insertion of the lining into the tube, an outer opening and an inner opening of rectangular shape with the outer opening of greater width than the inner opening, and a groove having a U shape.

In the third and fourth embodiments, in cross section and prior to the insertion of the lining into the tube, the inner opening of each slot can open out at the level of the inner face of the lining through a flared shape.

Whatever the embodiment, the slots can be aligned along a plurality of axes parallel to the longitudinal axis of the tube. Alternatively, the slots may be aligned along a plurality of helices centered on the longitudinal axis of the tube.

The lining can further comprise a plurality of channels each communicating with at least one slot, the channels opening out onto the side of the outer face of the lining and not opening out onto the side of the inner face of the lining. These channels thus ensure drainage of the permeation gas towards the slots.

The pipeline can further comprise an anti-corrosion coating applied on an inner face of the tube prior to the insertion of the liner.

### BRIEF DESCRIPTION OF THE DRAWINGS

FIG. 1 is a perspective view of a pipeline for the transport of fluids according to a first embodiment of the invention.

FIG. 2 is a cross-sectional view of a slot in the lining of the pipeline in FIG. 1 prior to its insertion into the tube.

FIG. 3 is a cross-sectional view of the slot in FIG. 2 after insertion of the lining into the tube.

FIG. 4 is a cross-sectional view of a slot in the lining of a pipeline according to a second embodiment of the invention prior to the insertion of the lining into the tube.

FIG. 5 is a cross-sectional view of the slot in FIG. 4 after insertion of the lining into the tube.

FIGS. 6A-6B are respectively perspective and cross-sectional views of a slot in the lining of a pipeline according to a third embodiment of the invention prior to the insertion of the lining into the tube.

FIG. 7 is a cross-sectional view of the slot in FIGS. 6A and 6B after insertion of the lining into the tube.

FIGS. 8A-8B are respectively perspective and cross-sectional views of a slot in the lining of a pipeline according to one variant of the third embodiment of the invention prior to the insertion of the lining into the tube.

FIG. 9 is a cross-sectional view of the slot in FIGS. 8A and 8B after insertion of the lining into the tube.

FIGS. 10A-10B are respectively perspective and cross-sectional views of a slot in the lining of a pipeline according to a fourth embodiment of the invention prior to the insertion of the lining into the tube.

FIG. 11 is a cross-sectional view of the slot in FIGS. 10A and 10B after insertion of the lining into the tube.

FIG. 12 is a perspective view showing one variant of distribution of the slots on the lining of the pipeline according to the invention.

FIG. 13 is a perspective view of a pipeline according to one variant of embodiment of the invention which is provided with an anti-corrosion coating applied on the inner face of the tube.

### DESCRIPTION OF THE EMBODIMENTS

The invention relates to any type of pipeline for the transport of fluids, in particular hydrocarbons but also hydrogen or CO₂, comprising a steel tube inside which the fluids to be transported flow, and an annular lining for protection against corrosion and/or abrasion which is made of polymer material and inserted inside the tube against an inner surface thereof.

The invention finds a preferred (but non-limiting) application to the subsea transport of hydrocarbons, particularly oil and gas, derived from subsea production wells.

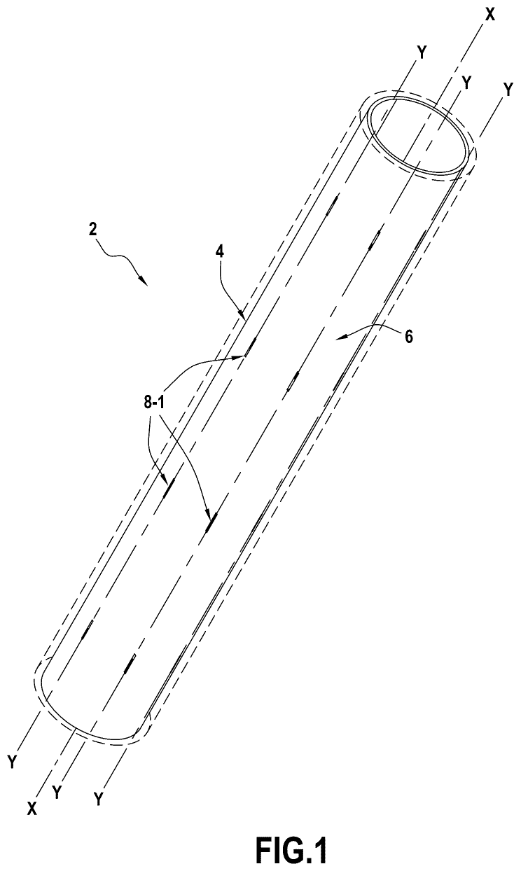

FIG. 1 is a perspective view of a pipeline 2 for the transport of fluids according to a first embodiment of the invention.

The pipeline 2 comprises a steel tube 4, for example carbon steel, having a longitudinal axis X-X and which is intended to receive the flow of fluids to be transported. The pipeline also comprises an annular protective lining 6 which is made of polymer material, inserted inside the tube 4 against an inner surface thereof and intended to ensure protection of the steel against corrosion of the fluids and/or abrasion.

As a non-limiting example, the lining can be made by extrusion of a thermoplastic material such as: high-density polyethylene (HDPE), polyamide (PA), polyvinylidene fluoride or polyvinylidene difluoride (PVDF), polyetheretherketone (PEEK), etc.

In a manner known per se, the lining can be inserted by deformation inside the tube according to a tight fit. In this case, the lining has, at rest (i.e. prior to its insertion into the tube), an external diameter which is slightly greater than the internal diameter of the tube. In this way, the insertion of the lining into the tube generates a contact pressure between the lining and the tube. Once inserted inside the tube, the internal and external diameters of the lining are therefore narrowed compared to the lining in its rest state.

According to the invention, the lining 6 comprises a plurality of slots 8-1 which extend in the direction of their length parallel to the longitudinal axis X-X of the tube 4. By “slot” it is meant here a narrow and elongate opening.

Moreover, these slots 8-1 are through slots between an inner face 6a and an outer face 6b of the lining 6, that is to say they are able to put these faces 6a, 6b in communication with each other.

More specifically, each slot 8-1 is open on the side of the inner face 6a of the lining when the lining 6 is at rest, that is to say prior its insertion into the tube 4, and at least partially closed between the inner face and the outer face of the lining along its depth (or thickness) once the lining is inserted into the tube.

In the first embodiment of the invention, the slots are more specifically closed at least partially on the side of the inner face 6a of the lining when the latter is inserted into the tube and this closing can result from two independent factors. Particularly, if the lining is dimensioned to be inserted by deformation inside the tube according to a tight fit, once inserted inside the tube, its internal and external diameters are necessarily narrowed compared to its rest state. This results in a closing of the slot on both sides, with a more pronounced closing on the inner side (which undergoes a greater diameter reduction). The other factor in closing the slots lies in the fact that the polymer material of the lining which is immersed in the transported fluids is typically subjected in service to a swelling by the hydrocarbons, naturally leading to the closing of the slots, which is more pronounced on the inner side.

It will be noted that the slots can be made after the phase of extrusion of the polymer material lining by the manufacturer, but must be made before insertion of the lining into the tube. They can be made on individual plastic tube joints such as those available from the factory or on greater lengths made from a longitudinal assembly of individual joints, depending on the chosen manufacturing method and its implementation.

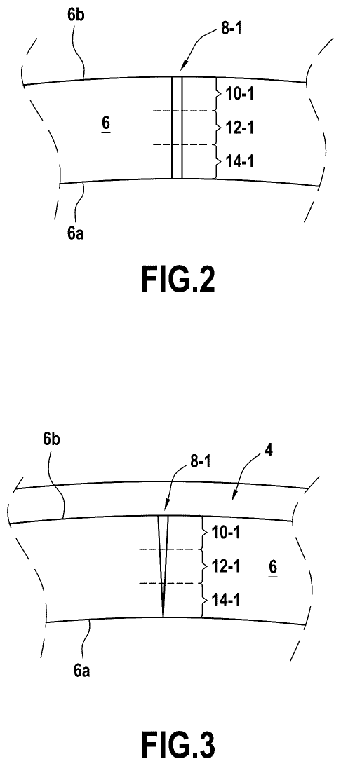

More specifically, as represented in FIG. 2, each slot 8-1 presents, in cross section and prior to the insertion of the lining into the tube, an outer opening 10-1 at the level of the outer face 6b of the lining which communicates via a groove 12-1 with an inner opening 14-1 at the level of the inner face 6a of the lining.

In the first embodiment represented in FIGS. 1 to 3, each slot has, in cross section and prior to the insertion of the lining into the tube, a rectangular shape with an outer opening 10-1, a groove 12-1 and inner opening 14-1 which have the same width (see FIG. 2).

Once the lining is inserted inside the tube 4 (FIG. 3), the internal and external diameters of the lining are reduced, causing at least partial—or even total—closing on the side of the inner face 6a of the lining.

This first embodiment is advantageous due to the simplicity of geometry and manufacture of the slots.

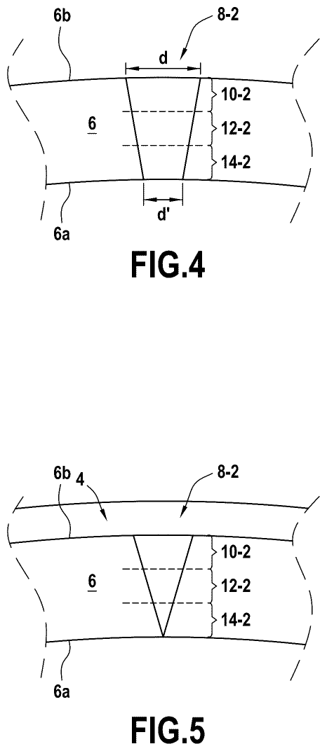

In the second embodiment represented in FIGS. 4 and 5, each slot 8-2 has, in cross section and prior to the insertion of the lining 6 into the tube 4, a trapezoid shape with an outer opening 10-2 having a width d greater than the width d′ of the inner opening 14-2.

Once the lining is inserted inside the tube (FIG. 5) or with the swelling of the liner in service, the internal and external diameters of the lining get narrower, causing at least partial—or even total—closing on the side of the inner face 6a of the lining (in the example of FIG. 5, the slot 8-2 thus deformed has, in cross section, a triangular shape).

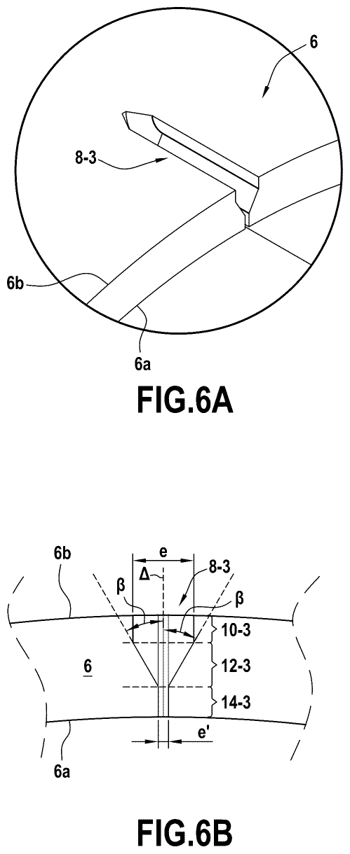

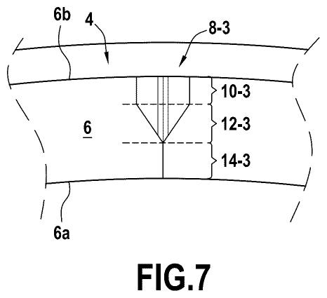

In the third embodiment represented in FIGS. 6A, 6B and 7, each slot 8-3 has, in cross section and prior to the insertion of the lining 6 into the tube 4, an outer opening 10-3 and an inner opening 14-3 each having a rectangular shape with the outer opening of width e greater than the width e′ of the inner opening, and a groove 12-3 having the shape of an isosceles trapezoid.

Once the lining is inserted inside the tube (FIG. 7), the internal and external diameters of the lining get narrower which causes at least partial—or even total—closing on the side of the inner face 6a of the lining (on the example of FIG. 7, the slot is completely closed on the side of the inner face).

Preferably, as represented in FIG. 6B, the outer opening 10-3 and the inner opening 14-3 of each slot 8-3 are aligned along the perpendicular bisector Δ of the groove 12-3, and the two non-parallel sides thereof form, in cross section, an angle β comprised between 20° and 45° with the perpendicular bisector Δ.

Such an angle β comprised between 20° and 45° makes it possible to smooth the profile of the slot and limit the effects of concentration of the stresses in the slots and at the ends thereof.

Of course, other dimensions can be envisaged depending on the dimensions, thickness, material and specific requirements of the application.

For example, in the rest position of the lining, each slot 8-3 measures approximately 50 mm in length and has an outer opening 10-3 comprised between 1 and 10 mm and an inner opening 14-3 comprised between 0.2 and 4 mm.

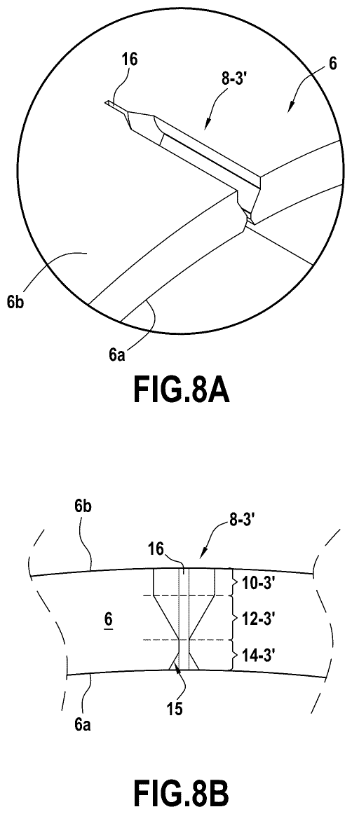

FIGS. 8A and 8B are respectively perspective and cross-sectional views of a slot 8-3′ of the lining of a pipeline according to one variant of the third embodiment of the invention prior to the insertion of the lining into the tube.

In this variant of embodiment, each slot 8-3′ has, in cross section and prior to the insertion of the lining into the tube, an inner opening 10-3′ which opens out at the level of the inner face 6a of the lining by a flared shape 15.

This flared slot design makes it possible to promote the opening on the inner side of the lining during the initiation of the buckling of the latter to facilitate the discharge of the permeation gases.

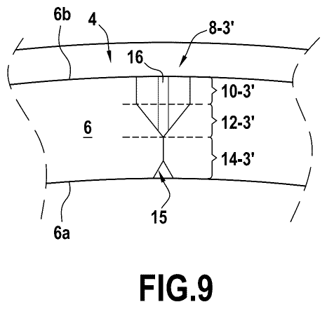

Once the lining is inserted inside the tube (FIG. 9) or with the swelling, the internal and external diameters of the lining get narrower, which causes at least partial—or even total—closing between the inner face and the outer face of the lining along its depth (in the example of FIG. 9, the slot is completely closed at the level of the non-flared part of its inner opening 14-3′).

Furthermore, as represented in particular in FIG. 8A in perspective, each slot 8-3 can open out at each longitudinal end at the level of a machining groove 16, the latter being the consequence of a machining of the slot by a specific funnel-shaped milling machine. The presence of such a groove can be avoided by means of a specific two-step machining sequence (instead of just one).

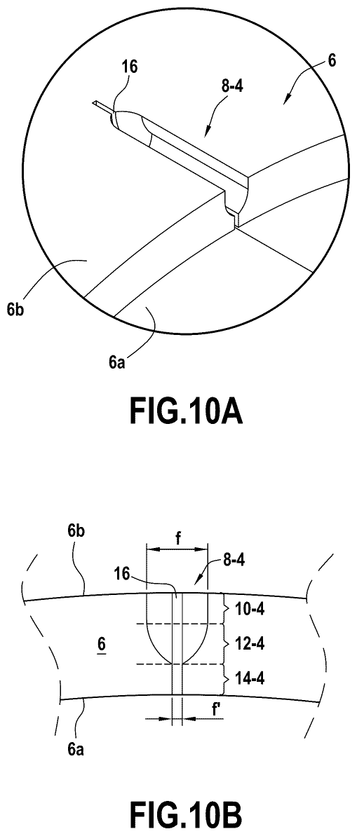

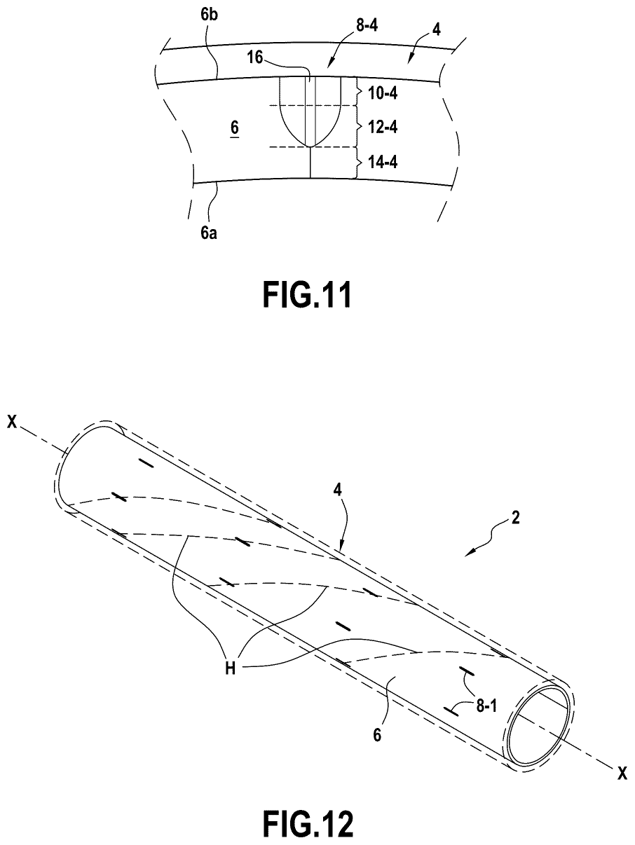

In a fourth embodiment represented in FIGS. 10A, 10B and 11, each slot 8-4 has, in cross section and prior to the insertion of the lining 6 into the tube 4, an outer opening 10-4 and an inner opening 14-3 each having a rectangular shape with the outer opening having a width f greater than the width f of the inner opening, and a groove 12-4 having a U shape.

Compared to the third embodiment, this specific shape of the slots makes it possible to limit stress concentrations at the level of the junctions between the groove 12-4 and the outer 10-4 and inner 14-4 openings.

Once the lining is inserted inside the tube (FIG. 11) or with the swelling, the internal and external diameters of the lining get narrower which causes at least partial—or even total—closing on the side of the inner face 6a of the lining (in the example of FIG. 11, the slot is completely closed on the side of the inner face).

It will be noted in FIG. 10A the presence of a machining groove 16 at each longitudinal end of the slots like the one described in relation to FIG. 8A (this groove can be avoided by means of a sequence of specific machining in two steps).

Whatever the embodiment envisaged for the slots, these each extend in the direction of their length parallel to the longitudinal axis X-X of the tube 4.

Moreover, as represented in FIG. 1, the slots can be distributed on the surface of the lining so as to be aligned along a plurality of Y axes parallel to the longitudinal axis X-X of the tube. This distribution helps reduce the risk of damage to the lining during the process of insertion into the tube and during the lifetime of the pipeline in the event of movement/displacement of the latter.

Alternatively, as represented in FIG. 12, the slots can be distributed on the surface of the lining 6 so as to be aligned along a plurality of helices H each centered on the longitudinal axis X-X of the tube 4. For example, these helices H can each form an angle of 45° with the longitudinal axis X-X. This distribution makes it possible to optimize the geometric distribution of the slots and therefore the discharge of the permeation gas while maintaining the risks of damage to the lining reduced.

Other slot distribution profiles can be envisaged depending on the specific requirements of the applications (such as transported fluid, operating pressure of the pipeline and authorized depressurization rate, dimensions of the pipeline, etc.). The objective remains to ensure that the differential pressure between the annular space and the interior of the pipeline is maintained below the collapse pressure.

Furthermore, and whatever the embodiment envisaged for the slots, the lining 6 can further comprise a plurality of channels (not represented in the figures) each communicating with at least one slot, these channels opening out onto the side of the outer face of the lining and not opening out onto the side of the inner face of the lining. Such channels ensure drainage of the permeation gas towards the slots.

With very good axial connectivity (that is to say ability of the permeation gas to move under the lining), the steps between the profile of the slots and the angular distribution thereof could be increased in order to have significantly fewer slots than those shown in FIGS. 1 and 12.

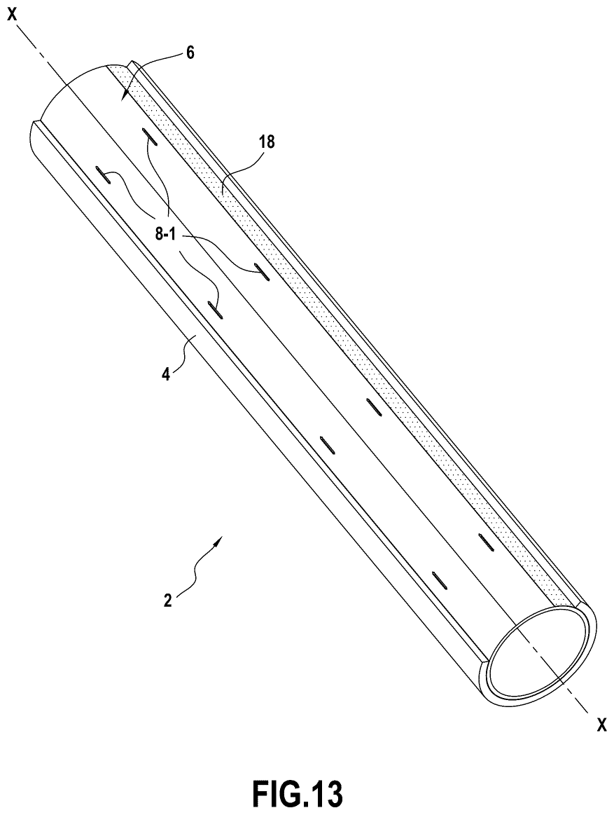

According to one advantageous arrangement of the invention represented in FIG. 13, the pipeline 2 further comprises a fine anti-corrosion coating 18 which is applied on the inner face of the tube prior to the insertion of the liner 6. The presence of the anti-corrosion coating allows additional protection against corrosion of the steel pipeline, by the coating and the lining, said coating itself being protected from abrasion and scratches by the presence of the lining.

1.-13. (canceled)

14. A pipeline for the transport of fluids comprising a steel tube intended to receive a flow of fluids to be transported, and an annular lining for protection against corrosion and/or abrasion made of polymer material, and inserted inside the tube,
wherein the lining comprises a plurality of slots which extend in the direction of their length parallel to a longitudinal axis of the tube and which pass all the way from an inner face to an outer face of the lining, each slot being open on the side of the inner face of the lining prior to the insertion of the lining into the tube, and at least partially closed between the inner face and the outer face of the lining along its depth once the lining is inserted into the tube.

15. The pipeline according to claim 14, wherein each slot has, in cross section and prior to the insertion of the lining into the tube, an outer opening at the level of the outer face of the lining which communicates via a groove with an inner opening at the level of the inner face of the lining.

16. The pipeline according to claim 15, wherein each slot has, in cross section and prior to the insertion of the lining into the tube, a rectangular shape with an outer opening having the same width as the inner opening.

17. The pipeline according to claim 15, wherein each slot has, in cross section and prior to the insertion of the lining into the tube, a trapezoid shape with an outer opening of greater width than the inner opening.

18. The pipeline according to claim 15, wherein each slot has, in cross section and prior to the insertion of the lining into the tube, an outer opening and an inner opening of rectangular shape with the outer opening of greater width than the inner opening, and a groove having the shape of an isosceles trapezoid.

19. The pipeline according to claim 18, wherein the outer and inner openings of each slot are aligned along the perpendicular bisector (Δ) of the groove, the two non-parallel sides of the groove forming, in cross section, an angle (β) comprised between 20° and 45° with the perpendicular bisector.

20. The pipeline according to claim 19, wherein, prior to the insertion of the lining into the tube, the outer opening of each slot measures between 1 and 10 mm and the inner opening of each slot measures between 0.2 and 4 mm.

21. The pipeline according to claim 15, wherein each slot has, in cross section and prior to the insertion of the lining into the tube, an outer opening and an inner opening of rectangular shape with the outer opening of greater width than the inner opening, and a groove having a U shape.

22. The pipeline according to claim 18, wherein, in cross section and prior to the insertion of the lining into the tube, the inner opening of each slot opens out at the level of the inner face of the lining through a flared shape.

23. The pipeline according to claim 14, wherein the slots are aligned along a plurality of axes parallel to the longitudinal axis of the tube.

24. The pipeline according to claim 14, wherein the slots are aligned along a plurality of helices centered on the longitudinal axis of the tube.

25. The pipeline according to claim 14, wherein the lining further comprises a plurality of channels each communicating with at least one slot, the channels opening out onto the side of the outer face of the lining and not opening out onto the side of the inner face of the lining.

26. The pipeline according to claim 14, further comprising an anti-corrosion coating applied on an inner face of the tube prior to the insertion of the liner.
